(19) United States
(12) Patent Application Publication
(10) Pub. No.: US 2004/0226218 A1
(43) Pub. Date: Nov. 18, 2004

(54) Fuel reforming apparatus and fuel cell system

(75) Inventors: Yasuhiro Izawa, Mishima-shi (JP); Takatoshi Masui, Mishima-shi (JP); Satoshi Iguchi, Mishima-shi (JP); Shigeru Ogino, Toyota-shi (JP); Koichi Numata, Mishima-shi (JP); Kenji Kimura, Toyota-shi (JP); Satoshi Aoyama, Susono-shi (JP); Masahiko Iijima, Iruma-gun (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 10/690,531

(22) Filed: Oct. 23, 2003

(30) Foreign Application Priority Data
Oct. 29, 2002 (JP) 2002-314089
Jun. 24, 2003 (JP) 2003-179840

(51) Int. Cl. B01J 7/00; C10J 1/00

(52) U.S. Cl. 48/127.9; 422/105; 429/17; 48/119; 48/61

(57) ABSTRACT

A fuel reforming apparatus includes a premixed fuel tank. In the premixed fuel tank, premixed fuel which is formed by emulsifying gasoline and water that are mixed with each other at a predetermined ratio, using a emulsifier. The premixed fuel is sprayed into a vaporizing portion through a nozzle. Heat can be supplied to the vaporizing portion by the reformer in which oxidation reaction proceeds, a first heating portion, and air supplied to the vaporizing portion through a heat exchanger. The premixed fuel sprayed into the vaporizing portion is vaporized immediately by the thus supplied heat, and is supplied to the reformer. In addition, air which has been humidified in a humidifying module cam be supplied to the vaporizing portion.

The disclosure of Japanese Patent Applications Nos. 2002-314089 filed on Oct. 29, 2002 and 2003-179840 filed on Jun. 24, 2003, each including the specification, drawings and abstract, are incorporated herein by reference in their entireties.

### BACKGROUND OF THE INVENTION

1. Field of the Invention

The invention relates to a fuel reforming apparatus which generates hydrogen using reforming reaction, and a fuel cell system including the fuel reforming apparatus.

2. Description of the Related Art

When hydrogen is generated by a stem reforming reaction, it is necessary to supply a reforming catalyst with hydrocarbon fuel as reformed fuel and water in vaporized states. In order to proceed with the reforming reaction smoothly, it is required that a ratio of supply amount between the hydrocarbon fuel and the water be adjusted to be within a predetermined range. When hydrophobic liquid hydrocarbon fuel such as gasoline was supplied for the reforming reaction as the reformed fuel, it was particularly difficult to adjust the ratio of supply amount between the hydrocarbon fuel and the water so as to be within the predetermined range. Since the hydrophobic liquid hydrocarbon fuel are not mixed with water easily, even when predetermined amounts of the hydrophobic liquid hydrocarbon fuel and the water are mixed with each other in piping, distributions thereof are uneven. Accordingly, when the hydrophobic liquid hydrocarbon fuel and the water are vaporized, concentration distributions in gas are uneven.

A configuration for reducing such inconvenience, a configuration is disclosed in, for example, Japanese Patent Laid-Open Publication No. 2002-12404. In this configuration, an agitating portion is provided between a fuel tank and a vaporizer, fuel is supplied from the fuel tank to the vaporizer, and the fuel and water are mixed with each other sufficiently by the agitating portion before being vaporized.

However, providing the agitating portion in addition to the fuel tank and the vaporizer causes a problem that a configuration for supplying the reformed fuel to a reformer becomes more complicated. Therefore, it has been desired that the configuration for supplying the reformed fuel be further simplified.

### SUMMARY OF THE INVENTION

The invention is made in order to solve the above-mentioned problem. Accordingly, it is an object of the invention to provide technology for stabilizing a ratio of supply amount between reformed fuel and water which are to be supplied for a reforming reaction at a predetermined value using a more simple configuration.

In order to attain the above-mentioned object, a fuel reforming apparatus according to a first aspect of the invention includes mixture state stabilizing means for maintaining a state in which the reformed fuel and the water that are to be supplied for the reforming reaction are mixed evenly; premixed fuel storing portion which stores the reformed fuel and the water as premixed fuel formed by mixing the reformed fuel and the water substantially evenly by the mixture state stabilizing means; a reformer which includes a reforming catalyst for promoting the reforming reaction; and a premixed fuel supplying portion which supplies the reformer with the premixed fuel stored in the premixed fuel storing portion.

According to the first aspect of the invention, the reformed fuel and the water are stored as the premixed fuel, and the state in which the reformed fuel and the water are mixed with each other substantially evenly is maintained by the mixture state stabilizing means. The premixed fuel is then supplied to the reformer including the reforming catalyst for promoting the reforming reaction.

According to the thus configured fuel reforming apparatus, since the reformed fuel and the water are stored in the state in which they are mixed with each other substantially evenly, it is possible to vaporize the reformed fuel and the water at a predetermined mixture ratio, without mixing the reformed fuel and the water prior to vaporization. Accordingly, the configuration for vaporizing the reformed fuel and the water at the predetermined mixture ratio can be simplified. Also, the ratio between the reformed fuel and the water which are to be supplied to the reformer can be stabilized.

In the first aspect of the invention, the reformed fuel may be hydrophobic liquid hydrocarbon. By using the hydrophobic liquid hydrocarbon fuel which is not mixed with water easily as the reformed fuel, the ratio between the reformed fuel and the water which are to be supplied for the reforming reaction can be further stabilized.

In the first aspect of the invention, the mixture state stabilizing means may be provided with an emulsifier which is mixed in the premixed fuel, and which makes the reformed fuel and the water stable emulsion. By using the emulsifier, the state in which the reformed fuel and the water are mixed evenly can be maintained easily.

In the fist aspect of the invention, the mixture state stabilizing means may include an agitating portion for agitating the reformed fuel and the water physically. According to such a configuration, it is possible to obtain the state in which the reformed fuel and the water are mixed with each other evenly in the premixed fuel, without using a component that is not directly related to the reforming reaction.

Furthermore, in order to attain the above-mentioned object, a fuel reforming apparatus according to a second act of the invention includes an additive agent having a function of maintaining a state in which the reformed fuel and the water that are to be supplied for the reforming reaction are mixed evenly; premixed fuel storing portion which stores the reformed fuel and the water as premixed fuel formed by mixing the reformed fuel and the water substantially evenly by the additive agent; a reformer which includes a reforming catalyst for promoting the reforming reaction; and a premixed fuel supplying portion which supplies the reformer with the premixed fuel stored in the premixed fuel storing portion.

According to the second aspect of the invention, the reformed fuel and the water are stored as the premixed fuel, and the state in which the reformed fuel and the water are mixed with each other substantially evenly is maintained by the additive agent. The premixed fuel is then supplied to the reformer including the reforming catalyst for promoting the reforming reaction.

According to the thus configured fuel reforming apparatus, since the reformed fuel and the water are stored in the state in which they are mixed with each other substantially evenly, it is possible to vaporize the reformed fuel and the water at a predetermined mixture ratio, without mixing the reformed fuel and the water prior to vaporization. Accordingly, the configuration for vaporizing the reformed fuel and the water at the predetermined mixture ratio can be simplified. Also, the ratio between the reformed fuel and the water which are to be supplied to the reformer can be stabilized.

In the first and second aspects of the invention, the premixed fuel supplying portion may include a vaporizing portion which is a predetermined space communicating with the reformer; a heating portion which supplies the vaporizing portion with heat for enabling the premixed fuel to be vaporized; and a spraying portion which sprays the premixed fuel stored in the premixed fuel storing portion into the vaporizing portion.

According to such a configuration, the premixed fuel which is formed by mixing the reformed fuel and the water evenly in advance can be vaporized instantaneously by being sprayed into the vaporizing portion. Accordingly, even when vaporization is performed, there is no possibility that the mixture ratio between the reformed fuel and the water differs from the predetermined ratio.

In the first and second aspects of the invention, an independent material supplying portion may be further provided which can supply the reformer with independent material that contains only one of the reformed fuel and the water, independently of the premixed fuel supplying portion.

According to such a configuration, the mixture ratio between the reformed fuel and the water which are to be supplied to the reformer can be adjusted so as to be a value different from the mixture ratio in the premixed fuel. Thus, it is possible to control the mixture ratio between the reformed fuel and the water in the reformer such that the efficiency of the reforming reaction is further enhanced. In the case where the independent material contains the reformed fuel, a temperature of the reforming catalyst can be increased by increasing the amount and the ratio of the reformed fuel to be supplied when the apparatus is started, the temperature of the reformer decreases or the like. In the case where the independent material contains water, the temperature of the reforming catalyst can be decreased by further adding water when the temperature of the reformer increases or the like.

In this case, the independent material may contain water, and the water may contain water generated in a system including the fuel reforming apparatus.

Thus, the cubic capacity of a water tank, which is provided in addition to a premixed fuel tank in order to prepare the water to be supplied to the reformer, can be reduced, or the water tank itself can be omitted. Since the water tank is not provided, and the required amount of water is obtained using the water generated in the system, there is no possibility that the water in the water tank is frozen when a temperature is low and the reforming reaction is hindered. Even when the temperature is low, by supplying the premixed fuel to the reformer, the reforming reaction can be started promptly.

The independent material supplying portion may further include a gas supplying portion which supplies the reformer with gas containing oxygen; and a humidifying portion which adds the water generated in the system in a form of steam to the gas containing oxygen, that is to be supplied from the gas supplying portion to the reformer.

According to such a configuration, in addition to the premixed fuel, the water to be supplied to the reformer is supplied to the gas containing oxygen in the form of steam. Accordingly, it is not necessary to further supply heat energy in order to vaporize the water to be supplied to the reformer, and the energy efficiency can be enhanced. In addition, since the water to be further added is supplied to the reformer in the form of steam, the premixed fuel and the water can be mixed in the form of gases. Accordingly, it is easy to mix the premixed fuel and the water at the predetermined ratio.

In the first and second aspects of the invention, the premixed fuel storing portion may make the ratio of the number of molecules of the water in the premixed fuel with respect to the number of the carbon atoms in the reformed fuel at least 0.5. Thus, even when the premixed fuel is supplied to the reformer without further adding water, it is possible to suppress occurrence of inconvenience such as generation of soot in the reformer.

In the first and second aspects of the invention, the premixed fuel storing portion may make the ratio of the number of molecules of the water in the premixed fuel with respect to the number of the carbon atoms in the reformed fuel at most 1.0. Thus, it is possible to obtain a sufficient amount of the reformed fuel in the premixed fuel while ensuring the efficiency of the reforming reaction sufficiently.

In the fist and second aspects of the invention, the premixed fuel supplying portion may include a premixed fuel temperature increasing portion which increases a temperature of the premixed fuel stored in the premixed fuel storing portion using heat of the gas containing the hydrogen generated by the reforming reaction; and a vaporizing portion which vaporizes the premixed fuel whose temperature has been increased in the premixed fuel temperature increasing portion before supplying the premixed fuel to the reformer.

In the first and second aspects of the invention, the premixed fuel supplying portion may further include a premixed fuel temperature increasing portion which increases the temperature of the premixed fuel using heat of the gas containing the hydrogen generated by the reforming reaction before spraying the premixed fuel into the vaporizing portion.

According to the above-mentioned configurations, by increasing the temperature of the premixed fuel which is formed by mixing the reformed fuel and the water whose boiling points are different from each other prior to the vaporization, it becomes easier to vaporize the premixed fuel while the mixture ratio between the reformed fuel and the water is maintained. Accordingly, it is possible to further stabilize the ratio between the reformed fuel and the water which are to be supplied to the reformer.

In addition, since the heat of the gas containing the hydrogen generated by the reforming reaction is used when the temperature of the premixed fuel is increased prior to the vaporization, the energy efficiency can be enhanced and the system can be simplified compared with a case in which heating means is further provided in order to heat the premixed fuel.

The invention is not limited to the above-mentioned embodiment, and the invention may be realized in various other embodiments. For example, the invention may be realized in a fuel cell system, a method for supplying reformed fuel to a reformer, and the like.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a diagram schematically showing a configuration of a fuel cell system 10 which is a preferred embodiment of the invention;

FIG. 2 is a flowchart showing a start time routine; and

FIG. 3 is a diagram schematically showing a configuration of a fuel cell system according to a second embodiment.

### DETAILED DESCRIPTION OF the PREFERRED EMBODIMENTS

Hereafter, embodiments of the invention will be described.

A. Entire Configuration of Apparatus

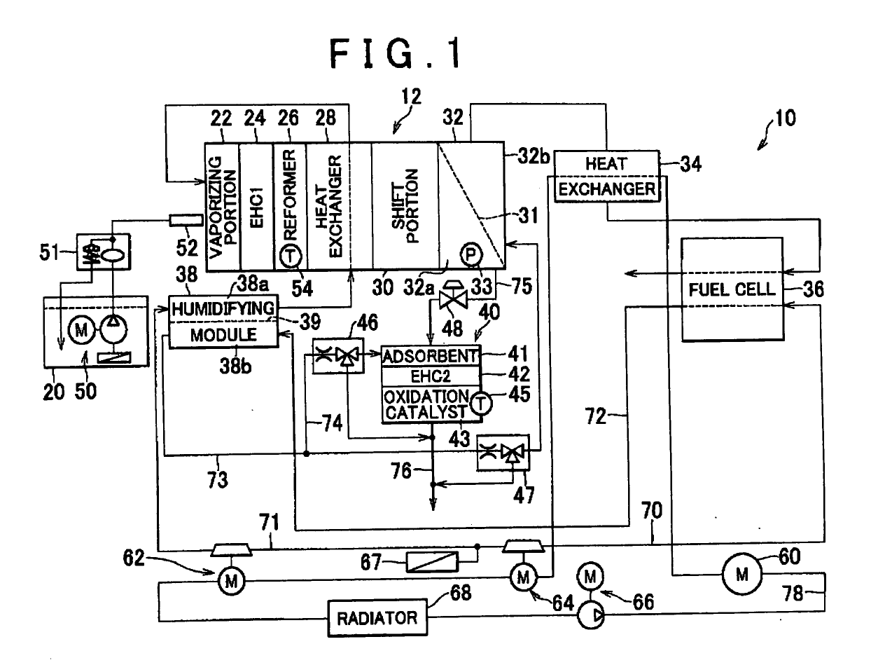

FIG. 1 is a diagram schematically showing a configuration of a fuel system 10 which is a preferred embodiment of the invention. The fuel cell system 10 according to a first embodiment is mounted on a vehicle, and is used as a power supply for driving the vehicle. The fuel cell system 10 includes a fuel cell 36 and a fuel reforming apparatus 12 for generating hydrogen to be supplied to the fuel cell 36. The fuel reforming apparatus 12 includes a premixed fuel tank 20, a vaporizing portion 22, a first heating portion 24 (EHC1), a reformer 26, a heat exchanger 28, a shift portion 30, and a hydrogen separating portion 32.

The premixed fuel tank 20 stores premixed fuel formed by mixing gasoline and water at a predetermined ratio. In the embodiment, the premixed fuel is used which is formed by mixing gasoline and water such that a ratio of the number of molecules of the water with respect to the number of carbon atoms in the gasoline (hereinafter, the ratio will be referred to as an S/C) is 0.5. In this case, the premixed fuel is emulsified by further mixing an additive agent such as an emulsifier (i.e., a surface active agent) in the gasoline and the water. In the vehicle on which the fuel cell system 10 is mounted, refueling is performed by supplying the premixed fuel tank 20 with the premixed fuel which is emulsified due to mixing of the surface active agent.

The value of the S/C in the premixed fuel is set such that the reforming reaction can proceed without hindrance (i.e., without occurrence of inconvenience such as generation of soot), even when the premixed fuel is supplied to the reformer 26 as it is, as described later. When the gasoline is used as the reformed fuel, it is desirable that the value of the S/C be set to at least 0.5, as the embodiment The emulsifier used for mixing the gasoline and the water needs to be able to emulsify the gasoline and the water with stability. For example, polyoxyethylene alkylene alkyl ether and a derivative thereof, polyoxyethylene lauryl ether or the like may be used. Particularly, it is preferable to use the emulsifier whose constituent elements are only oxygen, carbon and hydrogen, since inconvenience such as poisoning of the reforming catalyst can be prevented from occurring. When the degree of causing the poisoning of the reforming catalyst is within an allowable range, the emulsifier further containing another element such as sulfur and nitrogen may be used.

The premixed fuel stored in the premixed fuel tank 20 is supplied to a predetermined passage by a pump 50. Then, a pressure of the premixed fuel in the passage is adjusted to a predetermined value by a regulating valve 51, and the premixed fuel is sprayed from a nozzle 52 provided on an end portion of the passage into the vaporizing portion 22. The nozzle 52 includes an electromagnetic valve, and the amount of the premixed fuel sprayed into the vaporizing portion 22 is controlled by the open time of the electromagnetic valve. The vaporizing portion 22 is a space which is heated by the first heating portion 24, heat generated in and the reformer 26, and high-temperature humidified air which has passed through the heat exchanger 28. When being sprayed into the high-temperature vaporizing portion 22, the premixed fuel is vaporized instantaneously due to heat supplied from the high-temperature humidified air, and is mixed with the humidified air. The high-temperature humidified air will be described later in detail.

The first heating portion 24 is a heater, and can increase temperatures of the vaporizing portion 22 and the reform 26.

The reformer 26 includes the reforming catalyst, and proceeds with the reforming reaction so as to generate hydrogen when being supplied with the vaporized premixed fuel and the humidified air. The reformer 26 proceeds with a partial oxidation reaction using the oxygen in the humidified air, and performs the steam reforming reaction using heat generated by the partial oxidation reaction. The reformer 26 includes a novel metal catalyst containing novel metal such as platinum, nithenium, rhodium, palladium, and iridium, as the reforming catalyst for promoting the above-mentioned reaction. The reformer 26 includes a temperature sensor 54 for detecting an internal temperature (Trfm) of the reformer 26.

The temperature of the reformed gas rich in hydrogen, which is generated by the reforming reaction in the reformer 26, is decreased in the heat exchanger 28. Then, the reformed gas is supplied to the shift portion 30. Since a reaction temperature of the shift reaction which proceeds in the shift portion 30 is lower than a reaction temperature of the reforming reaction in the reformer 26, the temperature of the reformed gas is decreased using the heat exchanger 28. In order to supply the reformed gas from the reformer 26 operated at temperatures approximately 600° C. to 1000° C. to the shift portion 30 operated at temperatures approximately 200° C. to 600° C., the temperatures of the reformed gas is decreased to approximately 200° C. to 600° C. In the heat exchanger 28, the humidified air supplied from a humidifying module 38 is used, in order to exchange heat with the reformed gas and to decrease the temperature of the reformed gas. The shift portion 30 includes a shift catalyst which promotes the shift reaction for generating hydrogen and carbon dioxide from water and carbon monoxide, and decreases a carbon monoxide concentration in the reformed gas by proceeding with the shift reaction. As the shift catalyst, for example, a copper catalyst (such as a Cu/Zn catalyst) and a novel metal catalyst containing platinum may be used.

From the reformed gas whose carbon monoxide concentration is decreased in the shift portion 30, hydrogen is separated in the hydrogen separating portion 32. The hydrogen separating portion 32 includes a reformed gas portion 32a and an extracting portion 32b which are separated by a hydrogen separating membrane 31. The hydrogen separating membrane has a characteristic of selectively making hydrogen permeate therethrough, and is formed of palladium and a palladium alloy. The reformed gas whose carbon monoxide concentration is decreased in the shift portion 30 and which is supplied to the hydrogen separating portion 32 is introduced into the reformed gas portion 32a. In the reformed gas portion 32a, the hydrogen in the reformed gas permeates through the hydrogen separating membrane 31 to the extracting portion 32b side. As described later, exhaust gas emitted from a cathode side of the fuel cell 36 is supplied to the extracting portion 32b. By supplying gas which does not contain hydrogen, such as the cathode exhaust gas, to the extracting portion 32b, it is possible to maintain a large difference in the hydrogen concentration between the reformed gas portion 32a side and the extracting portion 32b side at all times, which enables efficient extraction of hydrogen.

Normally, oxygen remains in the cathode exhaust gas. Therefore, when such cathode exhaust gas is supplied to the extracting portion 32b, the oxygen in the cathode exhaust gas is with the hydrogen which has permeated through the hydrogen separating membrane 31. Namely, palladium and the like which form the hydrogen separating portion 32 functions as a catalyst, and a combustion reaction occurs in the hydrogen separating portion 32. By using the cathode exhaust gas for extracting hydrogen, a slight amount of hydrogen is consumed. However, the amount of hydrogen consumed due to the combustion reaction (the amount of hydrogen lost by combustion) is normally a small value of approximately 1%. For the purpose of extracting hydrogen, a configuration, in which another inert gas is supplied to the extracting portion 32b, may be adopted. Meanwhile, as mentioned above, by using the cathode exhaust gas, it is possible to suppress an increase in complexity of the system while maintaining the amount of the hydrogen lost by combustion within an allowable range

The hydrogen extracted from the reformed gas in the hydrogen separating portion 32 is mixed in the cathode exhaust gas, becomes fuel gas which does not actually contain carbon monoxide, is introduced to an anode side of the fuel cell 36, and is supplied for electrochemical reaction. A heat exchanger 34 is provided in the passage connecting the hydrogen separating portion 32 and the fuel cell 36. The heat exchanger 34 decreases the temperature of the fuel gas such that the temperature of the fuel gas comes close to an operating temperature of the fuel cell 36 before supplying the fuel gas to the fuel cell 36.

Meanwhile, as oxidizing gas related to a cell reaction in the cathode side of the fuel cell 36, air is used. The air used as the oxidizing gas is taken from the outside into an oxidizing gas supplying passage 70 through a filter 67, and is supplied to the fuel cell 36 by a blower 64 provided in the oxidizing gas supplying passage 70. An amount of the oxidizing gas to be supplied to the fuel cell 36 is adjusted by the blower 64.

The fuel cell 36 is a polymer electrolyte fuel cell, and is formed by stacking a plurality of unit cells each of which is a constitutional unit. By supplying the fuel gas containing hydrogen to the anode side of each unit cell and supplying the oxidizing gas containing oxygen to the cathode side of each unit cell se electrochemical reaction proceeds and an electromotive force is generated. An equation showing the electrochemical reaction which proceeds in the fuel cell 36 is as follows.

H₂→2H⁺+2e⁻ (1)

2H⁺+2e⁻+(½)O₂→H₂O (2)

H₂+(½)O₂→H₂O (3)

The equation (1) shows a reaction in the anode side, the equation (2) shows a reaction in the cathode side, and the equation (3) shows a reaction performed in the entire fuel cell. The electric force generated in the fuel cell 36 is supplied to a drive motor 60 of a vehicle on which the fuel cell system 10 is mounted.

The exhaust gas which remains in the cathode side of the fuel cell after the cell reaction is supplied to the humidifying module 38 through a cathode exhaust gas passage 72, and is used for humidifying the air to be supplied to the vaporizing portion 22. When the electrochemical reaction proceeds in the fuel cell 36, water is generated in the cathode side as shown by the equation (2). Since the cathode exhaust gas contains much steam, using the water, the air to be supplied to the vaporizing portion 22 is humidified.

The humidifying module 38 includes a humidifying portion 38a and a cathode exhaust gas portion 38b which are separated in a steam permeable membrane 39. The steam permeable membrane 39 has hydrogen permeability. For example, a hollow fiber membrane may be used. The cathode exhaust gas introduced into the cathode exhaust gas passage 72 is introduced into the cathode exhaust gas portion 38b. The air taken in an air passage 71 which branches off from the oxidizing gas supplying passage 70 is introduced into the humidifying portion 38a by a blower 62 provided in the air passage 71. The cathode exhaust gas contains more steam than air. Therefore, in accordance with the difference in steam partial pressure between the cathode exhaust gas and the air, steam permeates through the steam permeable membrane 39 from the cathode exhaust gas side to the air side.

The humidified air to which steam is added in the humidifying module 38 is supplied to the heat exchanger 28, the temperature of the humidified air is increased by performing heat exchange with the reformed gas, is supplied to the vaporizing portion 22 and is mixed in the premixed fuel. Accordingly, the steam added to the air in the humidifying module 38 is used for the steam reforming reaction and the shift reaction along with the water contained in the premixed fuel. The amount of steam added to the air (hereinafter, referred to as the “humidification amount”) in the humidifying module is decided based on the amount of the steam contained in the cathode exhaust gas emitted from, the fuel cell 36, the temperature of the humidifying module 38, the pressures of gases flowing with the steam permeable membrane 39 provided between the gas passages, and the like. In the fuel cell system 10 according to the embodiment, the humidification amount in the humidifying module 38 during steady operation of the fuel cell 36 is set such that the value of the S/C in the reformer 26 is approximately 1.0. The reforming reaction efficiency in the reformer 26 may be further enhanced by increasing the amount of the steam added to the premixed fuel using the humidified air. It is said that, in the case where gasoline is used as the reformed fuel, and the steam reforming reaction and the partial oxidation reaction are performed in combination, the efficiency of the reforming reaction is the highest when the value of the S/C in the reformer is approximately 2.0. The amount of the air to be supplied to the vaporizing portion 22 as the humidified air is adjusted using the drive amount of the blower 62 such that the ratio of the number of molecules of oxygen with respect to the number of carbon atoms in the gasoline (hereinafter, referred to as 0/C) is approximately 0.8.

Part of the cathode exhaust gas which remains after humidification of the air in the humidifying module 38 is introduced into the extracting portion 32b of the hydrogen separating portion 32 through a cathode exhaust gas passage 73, and is used for extracting hydrogen from the reformed gas, as mentioned above. A flow control valve 47 for adjusting the amount of the cathode exhaust gas to be supplied to the extracting portion 32b of the hydrogen separating portion 32 is provided in the cathode exhaust gas passage 73. In the embodiment, control is performed such that the amount of the cathode exhaust gas introduced into the extracting portion 32b of the hydrogen separating portion 32 is approximately 10% of the total amount of the cathode exhaust gas.

The gas which remains after the extraction of hydrogen from the reformed gas in the hydrogen separating portion 32 (the extraction exhaust gas) is supplied from the reformed gas portion 32a to a purifying portion 40 through an extraction exhaust gas passage 75. The extraction exhaust gas contains the hydrogen which remains after the extraction of hydrogen in separating portion 32, the hydrocarbon which remains after generation of hydrogen in the reformed 26, carbon monoxide and the like. The purifying portion 40 is a device for oxidizing the above mentioned components. A pressure sensor 33 for detecting an internal pressure is provided in the reformed gas portion 32a of the hydrogen separating portion 32, and a regulating valve 48 is provided in the extraction exhaust gas passage 75.

The purifying portion 40 includes an adsorbent 41, a second heating portion 42 (EHC2), an oxidation catalyst 43, and a temperature sensor 45 for detecting a temperature of the oxidation catalyst 43. The adsorbent 41 has a characteristic of adsorbing the above-mentioned components in the extraction exhaust gas when the temperature of the oxidation catalyst 43 is low, for example, during starting of the fuel cell system 10, and desorbing the components when the temperature increases. As the adsorbent 41, for example, a zeolitic adsorbent may be used. When the internal temperature of the purifying portion 40 is sufficiently high, the components including components desorbed from the adsorbent 41 are oxidized in the oxidation catalyst 43. The second heating portion 42 is a heater, and is used for heating the oxidation catalyst 43 and the adsorbent 41.

A cathode exhaust gas branch passage 74 which branches off from the cathode exhaust gas passage 73 is connected to the purifying portion 40. The cathode exhaust gas can be supplied to the purifying portion 40. In the oxidation catalyst 43, the oxidation reaction is performed using the oxygen remaining in the cathode exhaust gas. A flow control valve 46 for adjusting the amount of the cathode exhaust gas to be supplied to the purifying portion 40 is provided in the cathode exhaust gas branch passage 74. The oxidation exhaust gas generated by the oxidation reaction in the oxidation catalyst 43 is emitted outside through an oxidation exhaust gas passage 76. In order to supply the oxygen required for the oxidation reaction in the purifying portion 40, the air taken in from the outside may be used instead of the cathode exhaust gas.

A coolant passage 78 is further provided in the fuel cell system 10. The coolant passage 78 is provided so as to pass through the heat exchanger 34, the drive motor 60, the motors provided in the blower 62, 64, and cools them using the coolant flowing therein. Further, the coolant passage 78 is provided so as to pass through a radiator 68, and the coolant is cooled in the radiator 68. A pump 66 is provided in the coolant passage 78. By driving the pump 66, the coolant flows in the coolant passage 78 while exchanging heat with the above-mentioned portions.

The fuel cell system 10 further includes a control portion (not shown). The control portion is configured as a logic circuit mainly provided with a microcomputer, and includes a CPU, ROM, RAM and an input/output port which inputs/outputs various signals. The control portion obtains information concerning an operation state of the vehicle on which the fuel cell system 10 is mounted and a load requirement, outputs drive signals to various portions forming the fuel cell system 10, and controls an operation state of the entire fuel cell system 10.

The vehicle on which the fuel cell system 10 is mounted further includes a secondary cell (not shown) as a power supply different from the fuel cell 36. The secondary cell functions as a power supply for driving, which supplies electric power to the drive motor 60 during starting of the vehicle and the fuel cell system 10, and until the completion of warming-up of the fuel cell system 10. In the vehicle according to the embodiment, when a brake pedal of the vehicle is depressed, regenerative operation in which the drive motor 60 functions as a power generator is performed, and the secondary cell is charged with the electric power generated in the drive motor 60 due to the regenerative operation. The secondary cell may be charged by the fuel cell 36. When the load requirement in the drive motor 60 increases during steady operation after the completion of warming-up, the secondary cell in addition to the fuel cell 36 may supply electric power to the drive motor 60.

B. Operation in the Fuel Cell System 10:

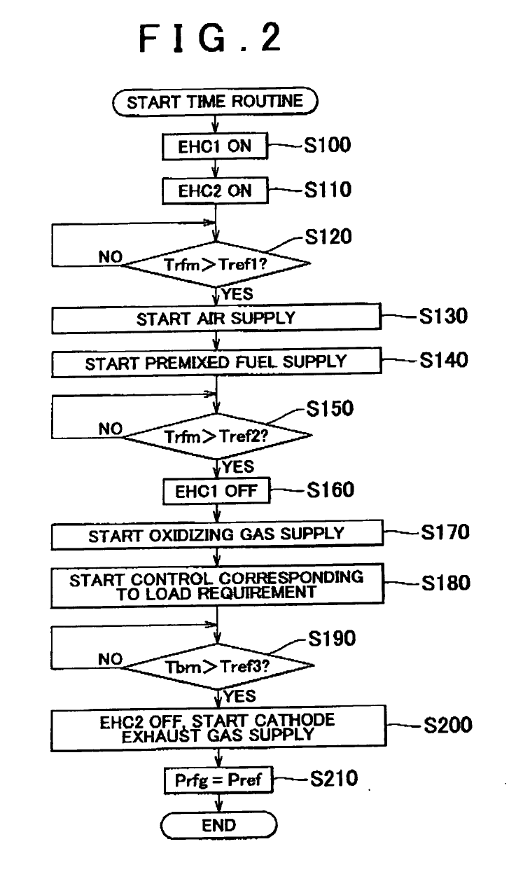

FIG. 2 is a flowchart showing a stating time routine performed by the control portion when the fuel cell system 10 is started. When the routine is performed, heating by the first heating portion 24 and the second heating portion 42 is started (step S100, S110). Thus, temperatures of the vaporizing portion 22, the reformer 26, and the oxidation catalyst 43 start to increase.

Next, a detection signal from the temperature sensor 54 provided in the reformer 26 is obtained, and an internal temperature Trfm and a predetermined first reference temperature Tref1 are compared with each other (step S120). The first reference temperature Tref1 is set for determining whether the temperature of the catalyst has been increased to a level at which the oxidation reaction (the combustion reaction) can be performed using the premixed fuel. In the embodiment, the fist reference temperature Tref1 is set to 350° C. When the temperature of the reformer 26 reaches the first reference temperature Tref1, the internal temperature of the vaporizing portion 22 is increased to a temperature at which the premixed fuel sprayed to the vaporizing portion 22 can be vaporized promptly.

The reformer 26 is heated by the first heating portion 24. When it is determined that the Trfm exceeds the first reference temperature Tref1 in step S120, the blower 62 is driven, and air supply to the vaporizing portion 22 is started (step S130), and the pump 50, the regulating valve 51, and the nozzle 52 are driven such that premixed fuel supply to the vaporizing portion 22 is started (step S140). When the air and the premixed fuel are supplied to the vaporizing portion 22, the oxidation reaction is started in the reformer 26. The amount of the premixed fuel to be supplied is determined in advance as the supply amount during warming-up starting time. The amount of the air to be supplied is set such that the ratio of the air supply amount with respect of the premixed fuel supply amount is a ratio appropriate for starting the oxidation reaction in the oxidation catalyst (a ratio appropriate for ignition). During starting, the oxidation reaction of the gasoline in the premixed fuel is performed actively, and the reforming catalyst is heated by heat from the first heating portion 24 and heat generated by the oxidation reaction. Since the oxidation reaction is started in the reformer 26, and the high-temperature gas is supplied to the heat exchanger 28, the air to be supplied to the vaporizing portion 22 is heated, and heat is further supplied to the vaporizing portion 22 by the air. During warming-up starting time, power generation is not started in the fuel cell 36, and the cathode exhaust gas is not supplied to the humidifying module 38. Accordingly, the air to be supplied to the vaporizing portion 22 is not humidified

Next, the detection signal from the temperature sensor 54 provided in the reformer 26 is obtained again, and the internal temperature Trfm of the reformer 26 and a predetermined second reference temperature Tref2 are compared with each other (step S150). The second reference temperature Tref2 is set for determining whether the temperature of the reforming catalyst has been increased to a level at which the reforming reaction can be performed. In the embodiment, the second reference temperature Tref2 is set to 500° C.

When it is determined that the Trfm exceeds the second reference temperature Tref2 in step S150, heating by the fist heating portion 24 is stopped (step S160). When the internal temperature Trfm of the reforming 26 reaches the second reference temperature tref2, and the temperature of the reforming catalyst is sufficiently increased, the temperature of the reforming catalyst can be sufficiently maintained by the oxidation reaction which proceeds in the reformer 26, without performing heating by the first heating portion 24. The premixed fuel sprayed t the vaporizing portion 22 can be vaporized sufficiently due to the heat conducted from the reforming catalyst to the vaporizing portion 22 and the air supplied to the vaporizing portion 22 through the heat exchanger 28.

The blower 64 is driven such that oxidizing gas supply to the fuel cell 36 is stared (step S170). and control corresponding to the load requirement is started (step S180). When the oxidizing gas supply is started, the cathode exhaust gas is supplied to the extracting portion 32b of the hydrogen separating portion 32 through the humidifying module 38. By supplying the cathode exhaust gas to the extracting portion 32b of hydrogen separating portion 32, the fuel gas supply to the anode side of the fuel cell 36 is performed more actively. By supplying the oxidizing gas along with the fuel gas, the electrochemical reaction proceeds in the fuel cell 36. When the electrochemical reaction proceeds in the fuel cell 36, the amount of the steam contained in the cathode exhaust gas increases, and the air to be supplied to the vaporizing portion 22 is humidified in the humidifying module 38. As mentioned above, in the extracting portion 32b of the hydrogen separating portion 32, a combustion reaction of the extracted hydrogen occurs using the oxygen in the cathode exhaust gas, by using the novel metal forming the hydrogen separating membrane 31 as a catalyst. Immediately after the oxidizing gas supply to the fuel cell 36 is started, the amount of the electrochemical reaction which proceeds in the fuel cell 36 is small and the amount of the oxygen remaining in the cathode exhaust gas is particularly large. Accordingly, the combustion reaction of the hydrogen occurs more actively on the hydrogen separating membrane 31. Thus, the temperature of the hydrogen separating membrane 31 increases, warming-up of the hydrogen separating portion 32 is promoted, and the hydrogen extraction efficiency in the hydrogen separating portion 32 is enhanced promptly.

When the control corresponding to the load requirement is started in step S180, control is performed such that the electric power corresponding to the load requirement is generated by the fuel cell 36 as much as possible, according to the warming-up state of the fuel cell 36. During a period after the vehicle is started until the warming-up of the fuel cell 36 is completed, there is a possibility that a required amount of electric power cannot be obtained from the fuel cell 36. Accordingly, as mentioned above, electric power is supplied to the load of the drive motor 60 or the like from the secondary cell. Therefore, when the oxidizing gas supply is started in step S170, and power generation is performed by the fuel cell 36, the amounts of the fuel gas and the oxidizing gas which are to be supplied to the fuel cell 36 are controlled according to the load requirement such that the required amount of electric power can be supplied from the fuel cell 36 as much as possible. More particularly, the amount of the premixed fuel to be supplied to the vaporizing portion 22 is adjusted by the valve 52 such that hydrogen can be generated and the amount of the hydrogen corresponds to the load requirement and the warming-up state. By adjusting the drive amount of the blower 62 such that the amount of the air to be supplied to the vaporizing portion 22 is an amount corresponding to the premixed fuel amount, heat required for the reforming reaction is generated by the partial oxidation reaction.

Next, the detection signal from the temperature sensor 45 is obtained, and the temperature Tbrn of the oxidation catalyst 43 and a predetermined third reference temperature Tref3 are compared with each other (step S190). The third reference temperature Tref3 is set for detaching whether the temperature of the oxidation catalyst 43 has been increased to a level at which the oxidation reaction can be performed. In the embodiment, the third reference temperature Tref3 is set to 350° C.

When it is determined that the Tbrn exceeds the third reference temperature Tref3 in step S190, heating by the second heating portion 42 is stopped, the flow control valve 46 is opened, and the cathode exhaust gas supply to the purifying portion 40 is started (step S200). By starting the supply of the cathode exhaust gas containing oxygen with the temperature of the oxidation catalyst 43 sufficiently increased, oxidation of each component in the extraction exhaust gas is performed in the oxidation catalyst 43. While the internal temperature of the purifying portion 40 including the oxidation catalyst 43 is low, each component in the extraction exhaust gas to be supplied to the purifying portion 40 is absorbed by the adsorbent 41, as mentioned above. When the internal temperature of the purifying portion 40 has been increased to a level at which the Tbrn is determined to exceed the Tref3 in step 190, each component is desorbed from the adsorbent 41, and is oxidized on the oxidation catalyst 43.

Then, the detection signal from the pressure sensor 33 is obtained, an internal pressure Prfg of the reformed gas portion 32a of the hydrogen separating portion 32 and a predetermined reference pressure Pref are compared with each other, and the regulating valve 48 is controlled such that the pressure Prfg is equal to the reference pressure Pref (step S210), after which the routine ends. The reference pressure Pref is set such that the difference between the internal pressure of the reformed gas portion 32a and the internal pressure of the extracting portion 32b is sufficiently large, and the hydrogen extraction efficiency in the hydrogen separating portion 32 is sufficiently high. In the embodiment, the reference pressure Pref is set to 300 kPa. By performing the routine, warming-up of the fuel cell system 10 ends.

C. Effects:

According to the thus configured fuel cell system 10 in the embodiment, the gasoline which is the reformed fuel is stored as the premixed fuel formed by mixing the gasoline and the water at the predetermined ratio. Accordingly, it is possible to easily vaporize the gasoline and the water at the predetermined mixture ratio, and the configuration for vaporizing the gasoline and the water at the predetermined ratio can be simplified. Also, the ratio between the gasoline and the water which are to be supplied to the reformer 26 can be stabilized. Since the gasoline and the water are sufficiently mixed at the predetermined ratio and then vaporized, it is possible to prevent the mixture ratio between the gasoline and the water from being different from the predetermined ratio. Especially, in the embodiment, the gasoline and the water are emulsified using the additive agent such as the surface active agent (the emulsifier). Accordingly, even when the hydrophobic liquid hydrocarbon such as the gasoline is used as the reformed fuel, it is possible to further stabilize and maintain the mixture state of the reformed fuel and the water, and the effect of stabilizing the mixture state can be obtained remarkably.

In the embodiment, since the premixed fuel which has been emulsified using the surface active agent is sprayed to the high-temperature vaporizing portion 22, the premixed fuel having the predetermined mixture ratio can be vaporized instantaneously. Accordingly, there is no possibility that the value of S/C becomes an undesirable value due to the operation of vaporization. Thus, it is possible to further enhance the effect of stabilizing the mixture ratio between the gasoline and the water (the S/C ratio in the reformer 26) which are to be supplied to the reformer 26.

In addition, when the air is further supplied to the reformer 26, the premixed fuel and the air, both of which are in the form of vapor, are mixed with each other in the vaporizing portion 22. Accordingly, the required mixture ratio can be realized easily. Further, since the first heating portion 24 for heating the vaporizing portion 22 and the reformer 26 is provided, during starting of the fuel cell system 10, by spraying the premixed fuel to the vaporizing portion 22 whose temperature has been increased and by supplying the premixed fuel to the reformer 26, the oxidation reaction and the reforming reaction can be started promptly. Therefore, compared with a case in which the liquid reformed fuel and the water are vaporized using a predetermined heat source, the time until the start of the reaction during starting can be greatly reduced.

In the embodiment, the mixture ratio in the premixed fuel is set to 0.5. Therefore, even when the premixed fuel is supplied to the reformer 26 without adding steam, it is possible to actually prevent soot from being generated in the reformer 26. Accordingly, there is no possibility that the activity of the reforming reaction is reduced and the reforming catalyst deteriorates due to adhesion of soot to the reforming catalyst. Thus, durability of the fuel reforming apparatus 12 can be enhanced. Also, by maintaining the value of the S/C in the premixed fuel in the range in which hindrance to the reforming reaction does not occur, and by suppressing the value as low as possible in the range, it is possible to enhance the efficiency of the oxidation reaction which proceeds in the reformer 26 during starting so as to enhance the efficiency during warming-up.

Further, in the embodiment, it is possible to supply the water to the reformer 26 independently of the premixed fuel. Accordingly, by further supplying water to the premixed fuel, it is possible to make the value of the S/C during the reforming reaction come closer to the optimum value so as to enhance the reforming efficiency. In this case, the humidifying module 38 is used in order to further supply the water to the premixed fuel. Therefore, it is possible to supply the water in the form of steam, and it is not necessary to provide a special configuration for vaporizing the water which is further to be supplied to the premixed fuel. Also, it is not necessary to further consume heat energy for vaporizing the water.

As mentioned above, by storing the premixed fuel in which the S/C is set such that the reforming reaction proceeds without hindrance even if the water is not further supplied and by proceeding with the reforming reaction while replenishing the steam as necessary, it is possible to maintain the reforming reaction in a good condition at all times even when the load fluctuates. For example, even when the load requirement increases abruptly, and the amount of steam corresponding to the increase cannot be added immediately, since the predetermined amount of water has been obtained as the premixed fuel, there is no possibility that an inconvenience occurs in the reforming reaction due to water shortage.

Particularly, in the embodiment, as the water further added to the premixed fuel, the water generated by the electrochemical reaction in the fuel cell 36 is used. Therefore, it is not necessary to provide a water tank in order to prepare the water which is to be further added to the premixed fuel. This is particularly advantageous when the fuel cell system is mounted on a movable body in which a space for mounting the fuel and the like is limited, such as the vehicle according to the embodiment. Since the water tank is not required, it is possible to provide a larger premixed fuel tank, and to increase a cruising distance of the movable body such as a vehicle. When the amount of the water which is to be further added to the premixed fuel cannot be obtained only by the water generated by the electrochemical reaction, the water tank for storing water may be provided in advance. In this case, by using the generated water, an effect of reducing the size of the water tank can be obtained.

In addition, in the embodiment, since the water tank is not provided, there is no possibility that the water in the water tank is frozen when the temperature is low. When the water to be supplied for the reforming reaction is stored in the water tank if the water in the water tank is frozen, the steam reforming reaction cannot be performed until the water is unfrozen. In the embodiment, the reforming reaction can be started immediately using the premixed having a freezing point which is much lower than that of water. As mentioned above, the water tank may be provided while using the water generated by the electrochemical reaction. In this case, even when the water in the water tank is frozen, the reforming reaction can be started immediately since the premixed fuel has been prepared.

D. Second Embodiment:

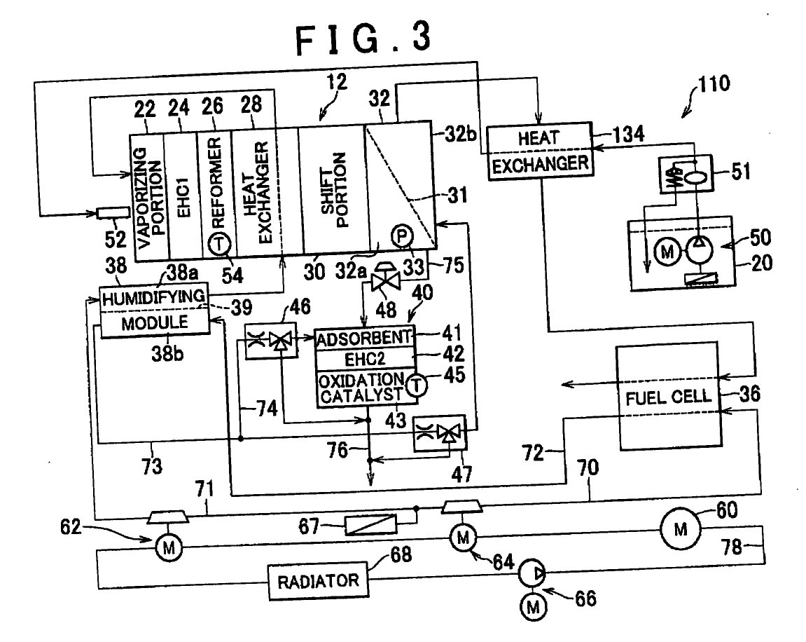

FIG. 3 is a diagram schematically showing a configuration of a fuel cell system 110 according to a second embodiment of the invention. Since the fuel cell system 110 according to the second embodiment has a configuration similar to that of the fuel cell system 10 according to the first embodiment, the same reference numbers are assigned to the common components, and detailed descriptions thereof will be omitted. In the fuel cell system 110 according to the second embodiment, the same control as the fuel cell system 10 according to the first embodiment is performed. Hereafter, only the configurations of the fuel cell system 110 according to the second embodiment which are different from those of the fuel cell system 10 according to the first embodiment will be described.

In the fuel cell system 110, the premixed fuel stored in the premixed fuel tank 20 passes through a heat exchanger 134, and is then sprayed from the nozzle 52 into the vaporizing portion 22. The heat exchanger 134 is configured such that the fuel gas which is emitted from the hydrogen separating portion 32 and is to be supplied to the fuel cell 36 passes therethrough, as in the case of the heat exchanger 34 according to the fist embodiment. In the heat exchanger 134, heat is exchanged between the premixed fuel and the fuel gas. Accordingly, since the premixed fuel passes through the heat exchanger 134, the temperature of the premixed fuel is increased before the premixed fuel is sprayed from the nozzle 52, and the temperature of the fuel gas is decreased before the fuel gas is supplied to the fuel cell 36.

According to the thus configure fuel cell system 10 in the second embodiment, by increasing the temperature of the premixed fuel in the heat exchanger 134, the premixed fuel becomes easier to vaporize, and the configuration for vaporizing the premixed feel can be further simplified. Since the premixed fuel becomes easier to vaporize, the ratio between the gasoline and water which are to be supplied to the reformer 26 can be further stabilized.

Also, by increasing the temperature of the premixed fuel sprayed to the vaporizing portion 22, it is possible to reduce the amount of the oxidation reaction which proceeds in the reformer 22 in order to heat the vaporizing portion 22. Namely, it is possible to reduce the amount of the air to be introduced into the vaporizing portion 22, and to further decrease the value of the O/C in the reformer 26. Thus, the efficiency of generating hydrogen in the reformer 26 can be enhanced.

In addition, in the embodiment, since the premixed fuel is heated by heat exchange with the fuel gas emitted from the hydrogen separating portion 32, the entire apparatus can be compact compared with a case where a heating device such as a combustor is provided for heating the premixed fuel. Particularly, in the embodiment, as the fuel cell 36, a polymer electrolyte fuel cell having an operating temperature which is lower than that of the hydrogen separating portion 32 is used. Accordingly, by heating the premixed fuel using the fuel gas emitted from the hydrogen separating portion 32, it is possible to perform operation for heating the premixed fuel and operation for decreasing the temperature of the fuel gas to be supplied to the fuel cell 36 to a temperature corresponding to the fuel cell 36, simultaneously. When the gas, which is generated in the fuel cell system 110 and whose temperature needs to be decreased, is used in order to heat the premixed fuel, there is no possibility that the system efficiency is reduced by heating the premixed fuel.

In the embodiment, the temperature of the premixed fuel is increased using the fuel gas emitted from the hydrogen separating portion 32. However, a different configuration may be adopted. For example, when the hydrogen extraction in the hydrogen separating membrane 31 can be performed at a temperature sufficiently lower than the operating temperature of the shift portion 30, heat exchange may be performed between the reformed gas omitted from the shift portion 30 and the premixed fuel before the hydrogen extraction in the hydrogen separating membrane 31. Also, heat exchange may be performed between the extraction exhaust gas which remains after the hydrogen extraction and the premixed fuel.

Gas containing the hydrogen, other than the gas containing the hydrogen supplied to the hydrogen separating portion 32 may be used as a heat source for increasing the temperature of the premixed fuel. For example, in the heat exchanger 28, a premixed fuel passage may be provided instead of the humidified air passage, or in addition to the humidified air passage. Thus, the temperature of the premixed fuel can be increased using heat of the reformed gas emitted from the reformer 26. By increasing the temperature of the premixed fuel using the heat of the gas containing the hydrogen generated by the reforming reaction, a decrease in the efficiency of the fuel cell system 110 can be suppressed.

E Modified Examples:

The invention is not limited to the above-mentioned embodiments, and the invention may be realized in various other embodiments within the scope of the invention. For example, the following elements can be realized.

E1. Modified Example 1:

A configuration of the fuel cell system including the fuel reforming apparatus 12 according to the first embodiment and the second embodiment may be different from that of the above-mentioned embodiments. For example, the reformed gas generated in the reformer 26 may be supplied to the hydrogen separating portion 32 as it is, without providing the shift portion 30. Alternatively, a CO selectively oxidizing portion including a CO selectively oxidation catalyst for selectively oxidizing carbon monoxide may be provided between the shift portion 30 and the hydrogen separating portion 32 such that the reformed gas whose carbon monoxide concentration is further reduced is supplied to the hydrogen separating portion 32. In the first embodiment, the reformed gas whose carbon monoxide concentration is reduced in the shift portion and the CO reducing portion may be supplied to the fuel cell 36 as it is without providing the hydrogen separating portion 32.

In the first embodiment and the second embodiment, by supplying the steam necessary for the shift reaction and the steam necessary for the reforming reaction through the vaporizing portion 22, the configuration for supplying the steam to be supplied for the shift reaction is simplified. However, a different configuration may be adopted. Namely, the steam to be supplied for the shift reaction may be added on a downstream side with respect to the reformer.

E2. Modified Example 2:

In the first embodiment and the second embodiment, the mixture ratio between the gasoline and the water in the premixed fuel stored in the premixed fuel tank 20 is 0.5. However the mixture ratio may be different from 0.5. However, when warming-up is performed by oxidizing the premixed fuel during starting, as the amount of the water mixed in the premixed fuel is increased, the efficiency of the warming is reduced. Also, as the amount of the water mixed in the premixed fuel is increased, the amount of the reformed fuel which can be mounted on the vehicle is decreased. Accordingly, the cruising distance of the vehicle is decreased. Therefore, it is preferable that the S/C be at most 1.0 in the premixed fuel.

E3. Modified Example 3:

In the first embodiment and the second embodiment, the steam reforming reaction and the partial oxidation reaction are performed in the reformer 26. However, only the steam reforming reaction may be performed. In this case, a heat source for supplying heat necessary for the steam reforming reaction needs to be provided. For example, it is possible to burn the hydrogen remaining in the anode exhaust gas, and use the heat generated by the combustion reaction. When only the stem reforming reaction is performed, it is not necessary to supply the gas containing oxygen such as the cathode exhaust gas to the reformer. Accordingly, in such a case, a required amount of water needs to be sprayed to the vaporizing portion 22 using a nozzle as in the case of the premixed fuel so as to be vaporized instantaneously, and needs to be further mixed with the premixed fuel.

E4. Modified Example 4:

In the first embodiment and the second embodiment, gasoline is used as the reformed fuel mixed in the premixed fuel. However, different reformed fuel may be used. By storing the premixed fuel formed by mixing the reformed fuel and water at a ratio within a predetermined range, the same effects can be obtained. Particularly, when hydrophobic liquid hydrocarbon is used as the reformed fuel as in the case of the gasoline, the effect of stabilizing the mixture ratio between the reformed fuel and water can be obtained remarkably. The value of the S/C in the premixed fuel needs to be set depending on the reformed fuel to be used, based on the minimum amount necessary for proceeding the reforming reaction without hindrance and the efficiency during starting.

E5. Modified Example 5:

In the first embodiment and the second embodiment, steam can be supplied to the reformer 26 in addition to the premixed fuel. However, the reformed fuel which does not contain water can be supplied independently of the premixed fuel. According to such a configuration, it is possible to increase the ratio of the reformed fuel to be supplied to the reformer, and increase the temperature of the catalyst more promptly during starting or when the temperature is decreased

By providing an independent material supplying portion for supplying the reformer with the independent material which contains only one of the reformed fuel and the water independently of the premixed fuel, it is possible to supply the reformed fuel and the water to the reformer at a ratio different from that of the premixed fuel stored in the premixed fuel tank. Particularly, in the case where water (steam) can be supplied independently, when the temperature of the reformed catalyst has been increased to an undesirable level, it is possible to increase the water supply amount and decrease the temperature of the catalyst. When the reformed fuel can be supplied independently, it is possible to increase the temperature of the catalyst by performing the oxidation reaction of the larger amount of the reformed fuel. Thus, by controlling the amount of the independent material to be supplied, it is possible to control the temperature of the catalyst.

E6. Modified Example 6:

In the first embodiment and the second embodiment, the air to be supplied to the reformer 26 (the air for the partial oxidation reaction) is humidified using the steam in the cathode exhaust gas. However, humidification may be performed using another steam, in the same humidifying module. For example, the steam in the anode exhaust gas may be used.

Alternatively, a combustion portion for burning the hydrogen which remains in the anode exhaust gas may be further provided, and the steam generated due to the combustion reaction in the combustion portion may be used. Also, the steam which is generated by burning the unreacted reformed fuel and CO that remain in the extraction exhaust gas emitted from the hydrogen separating portion 32 in the oxidation catalyst may be used. In addition, humidification may be performed by combining two or more types of steam emitted from the above-mentioned portions. In this case, when the humidifying modules are connected to the air passage in an order from the humidifying module using the gas containing the smallest amount of steam to the humidifying module using the gas containing the largest amount of steam the efficiency of the humidification can be ensured. Also, the steam generated in another portion of the apparatus including the fuel cell system may be used.

In any of the above-mentioned cases, since the water to be supplied for the reforming reaction is supplied using the humidifying module, the device for vaporizing the water by heating is not required, and the configuration of the system can be simplified. Also, since it is not necessary to consume energy particularly for vaporizing the water, the energy efficiency of the entire apparatus can be enhanced. Also, since the steam generated by the combustion reaction is used, sensible heat of the combustion gas can be used. When the air is humidified in the humidifying module 38, heat exchange is performed between the combustion gas and the air. Accordingly, the temperature of the humidified air can be further increased. Therefore, even when the load requirement is abruptly increased, and the amount of reforming reaction is abruptly increased, it is possible to maintain the temperature of the reforming catalyst using the heat of the combustion gas.

E7. Modified Example 7:

In the first embodiment and the second embodiment, in order to stably maintain the mixture state of the premixed fuel formed by mixing the reformed fuel and the water, the emulsifier is used. However, in order to maintain the state where the reformed fuel and the water are mixed substantially evenly in the premixed fuel tank, agent or material different from the emulsifier may be used. In addition, as the mixture state stabilizing means, for example, an agitating portion for physically mixing the reformed fuel and the water may be provided in the premixed fuel tank. By continuing to mix the premixed fuel, it is possible to store the evenly mixed premixed fuel in the tank. Alternatively, an ultrasound oscillator may be provided in the premixed fuel tank is order to stabilize the mixture state using the ultrasound energy. The premixed fuel needs to be stored substantially evenly. When a predetermined mixture state stabilizing means is provided in the premixed fuel tank, the entire apparatus can be compact compared with a case where an agitating device or the like is provided in addition to the tank and the vaporizer.

What is claimed is:

1. A fuel reforming apparatus for generating hydrogen by reforming reaction, comprising:
a premixed fuel storing portion which includes mixture state stabilizing means for maintaining a state in which reformed fuel and water that are to be supplied for the reforming reaction are mixed evenly, and stores the reformed fuel and the water as premixed fuel formed by mixing the reformed fuel and the water substantially evenly by the mixture state stabilizing means;
a reformer which includes a reforming catalyst for promoting the reforming reaction; and
a premixed fuel supplying portion which supplies the reformer with the premixed fuel stored in the premixed fuel storing portion.

2. The fuel reforming apparatus according to claim 1, wherein the reformed fuel is hydrophobic liquid hydrocarbon.

3. The fuel reforming apparatus according to claim 1, wherein the mixture state stabilizing means is provided with an emulsifier which is mixed in the premixed fuel, and which makes the reformed fuel and the water stable emulsion.

4. The fuel reforming apparatus according to claim 1, wherein the mixture state stabilizing means includes an agitating portion for agitating the reformed fuel and the water physically.

5. The fuel reforming apparatus according to claim 1, wherein the premixed fuel supplying portion includes:
a vaporizing portion which is a predetermined space communicating with the reformer;
a heating portion which supplies the vaporizing portion with heat for enabling the premixed fuel to be vaporized; and
a spraying portion which sprays the premixed fuel stored in the premixed fuel storing portion into the vaporizing portion.

6. The fuel reforming apparatus according to claim 5, wherein the premixed fuel supplying portion includes a premixed fuel temperature increasing portion which increases a temperature of the premixed fuel using heat of the gas containing hydrogen, generated by the reforming reaction before spraying the premixed fuel into the vaporizing portion.

7. The fuel reforming apparatus according to claim 1, further comprising:
an independent material supplying portion which supplies the reformer with independent material that contains one of the reformed fuel and the water and that does not contain the other, independently of the premixed fuel supplying portion.

8. The fuel reforming apparatus according to claim 7, wherein the independent material contains water, and the water contains water generated in a system including the fuel reforming apparatus.

9. The fuel reforming apparatus according to claim 8, wherein the independent material supplying portion includes:
a gas supplying portion which supplies the reformer with gas containing oxygen; and
a humidifying portion which adds the water generated in the system in a form of steam to the gas containing oxygen, that is to be supplied by the gas supplying portion to the reformer.

10. The fuel reforming apparatus according to claim 9, wherein the humidifying portion includes:
a first passage through which the gas containing oxygen flows;
a second passage through which the water generated in the system flows in a form of steam; and
a hydrogen permeable membrane which is provided between the first passage and the second passage, and through which steam permeates from a side in which steam partial pressure high to a side in which steam partial pressure is low.

11. The fuel reforming apparatus according to claim 1, wherein the premixed fuel storing portion makes a ratio of the number of molecules of the water in the premixed fuel with respect to the number of carbon atoms in the reformed fuel at least 0.5.

12. The fuel reforming apparatus according to claim 1, wherein the premixed fuel storing portion makes a ratio of the number of molecules of the water in the premixed fuel with respect to the number of carbon atoms in the reformed fuel at most 1.0.

13. The fuel reforming apparatus according to claim 1, wherein the premixed fuel supplying portion includes:
a premixed fuel temperature increasing portion which increases a temperature of the premixed fuel stored in the premixed fuel storing portion using heat of gas containing the hydrogen generated by the reforming reaction; and
a vaporizing portion which vaporizes the premixed fuel whose temperature has been increased in the premixed fuel temperature increasing portion before supplying the premixed fuel to the reformer.

14. A fuel cell system, comprising:
the fuel reforming apparatus according to claim 1; and
a fuel cell which generates an electromotive force by an electrochemical reaction using hydrogen generated in the fuel reforming apparatus.

15. A fuel cell system, comprising:
the fuel reforming apparatus according to claim 8; and
a fuel cell which generates an electromotive force by an electrochemical reaction using hydrogen generate in the fuel reforming apparatus,
wherein the water supplied from the independent material supplying portion contains water generated in the fuel cell.

16. The fuel cell system according to claim 15, wherein the water supplied from the independent material supplying portion contains water in exhaust gas emitted from an anode side of the fuel cell.

17. The fuel cell system according to claim 15, wherein the water supplied from the independent material supplying portion contains water in exhaust gas emitted from a cathode side of the fuel cell.

18. The fuel cell system according to claim 15, further comprising:
a first combustion portion which burns hydrogen that remains in exhaust gas emitted from an anode of the fuel cell, wherein the water supplied from the independent material supplying portion contains water generated in the first combustion portion.

19. The fuel cell system according to claim 15, further comprising:
a hydrogen separating portion which includes a hydrogen permeable membrane that selectively makes hydrogen permeate therethrough, and which separates hydrogen in gas emitted from the fuel reforming apparatus using the hydrogen permeable membrane;
a hydrogen supplying portion which supplies the fuel cell with the hydrogen separated in the hydrogen separating portion; and
a second combustion portion which burns gas that remains after separation of hydrogen in the hydrogen separating portion, wherein the water supplied from the independent material supplying portion contains water generated in the second combustion portion.

20. A fuel cell system, comprising:
the fuel reforming apparatus according to claim 6; and
a fuel cell which generates an electromotive force by an electrochemical reaction, wherein the fuel reforming apparatus includes a hydrogen extracting potion having a hydrogen permeable membrane which selectively makes hydrogen permeate therethrough, and extracts hydrogen from gas containing hydrogen using the hydrogen permeable membrane by being supplied with the gas containing hydrogen generated in the reformer, and operates at a temperature that is higher than that of the fuel cell, and the premixed fuel temperature increasing portion increases a temperature of the premixed fuel using the hydrogen extraction by the hydrogen extracting portion, and supplies the hydrogen used for increasing the premixed fuel for the electrochemical reaction in the fuel cell.

21. the fuel reforming apparatus according to claim 13; and
a fuel cell which generates an electromotive force by an electrochemical reaction, wherein the fuel reforming apparatus includes a hydrogen extracting portion having a hydrogen permeable membrane which selectively makes hydrogen permeate therethrough, and extracts hydrogen from gas containing hydrogen using the hydrogen permeable membrane by being supplied with the gas containing hydrogen generated in the reform, and operates at a temperature that is higher than that of the fuel cell, and the premixed fuel temperature increasing portion increases a temperature of the premixed fuel using the hydrogen extracted by the hydrogen extracting portion, and supplies the hydrogen used for increasing the premixed fuel for the electrochemical reaction in the fuel cell.

22. A fuel reforming apparatus for generating hydrogen by reforming reaction, comprising:
a premixed fuel storing portion which includes an additive agent maintaining a state in which reformed fuel and water that are to be supplied for the reforming reaction are mixed evenly, and stores the reformed fuel and the water as premixed fuel formed by mixing the reformed fuel and the water substantially evenly by the additive agent;
a reformer which includes a reforming catalyst for promoting the reforming reaction; and
a premixed fuel supplying portion which supplies the reformer with the premixed fuel stored in the premixed fuel storing portion.

23. The fuel reforming apparatus according to claim 22, wherein the reformed fuel is hydrophobic liquid hydrocarbon.

24. The fuel reforming apparatus according to claim 22, wherein the additive agent is an emulsifier which is mixed in the premixed fuel, and which makes the reformed fuel and the water stable emulsion.

25. The fuel reforming apparatus according to claim 22, wherein the premixed fuel supplying portion includes:
a vaporizing portion which is a predetermined space communicating with the reformer,
a heating portion which supplies the vaporizing portion with heat for enabling the premixed fuel to be vaporized, and
a spraying portion which sprays the premixed fuel stored in the premixed fuel storing portion into the vaporizing portion.

26. The fuel reforming apparatus according to claim 25, wherein the premixed fuel supplying portion includes a premixed fuel temperature increasing portion which increases a temperature of the premixed fuel using heat of the gas containing hydrogen, generated by the reforming reaction before spraying the premixed fuel into the vaporizing portion.

27. The fuel reforming apparatus according to claim 22, further comprising:
an independent material supplying portion which supplies the reformer with independent material that contains one of the reformed fuel and the water and that does not contain the other, independently of the premixed fuel supplying portion.

28. The fuel reforming apparatus according to claim 27, wherein the independent material contains water, and the water contains water generated in a system including the fuel reforming apparatus.

29. The fuel reforming apparatus according to claim 28, wherein the independent material supplying portion includes:
a gas supplying portion which supplies the reformer with gas containing oxygen; and
a humidifying portion which adds the water generated in the system in a form of steam to the gas containing oxygen, that is to be supplied by the gas supplying portion to the reformer.

30. The fuel reforming apparatus according to claim 29, wherein the humidifying portion includes;
a first passage through which the gas containing oxygen flows;
a second passage through which the water generated in the system flows in a form of steam; and
a hydrogen permeable membrane which is provided between the first passage and the second passage, and through which steam permeates from a side in which steam partial pressure high to a side in which steam partial pressure is low.

31. The fuel reforming apparatus according to claim 22, wherein the premixed fuel storing portion makes a ratio of the number of molecules of the water in the premixed fuel with respect to the number of carbon atoms in the reformed fuel at least 0.5.

32. The fuel reforming apparatus according to claim 22, wherein the premixed fuel storing portion makes a ratio of the number of molecules of the water in the premixed fuel with respect to the number of carbon atoms in the reformed fuel at most 1.0.

33. The fuel reforming apparatus according to claim 22, wherein the premixed fuel supplying portion includes:
a premixed fuel temperature increasing portion which increases a temperature of the premixed fuel stored in the premixed fuel storing portion using heat of gas containing the hydrogen generated by the reforming reaction; and
a vaporizing portion which vaporizes the premixed fuel whose temperature has been increased in the premixed fuel temperature increasing portion before supplying the premixed fuel to the reformer.

34. A fuel cell system, comprising:
the fuel reforming apparatus according to claim 22; and
a fuel cell which generates an electromotive force by an electrochemical reaction using hydrogen generated in the fuel reforming apparatus.

35. A fuel cell system, comprising:
the fuel reforming apparatus according to claim 28; and
a fuel cell which generates an electromotive force by an electrochemical reaction using hydrogen generated in the fuel reforming apparatus,
wherein the water supplied from the independent material supplying portion contains water generated in the fuel cell.

36. The fuel cell system according to claim 35, wherein the water supplied from the independent material supplying portion contains water in exhaust gas emitted from an anode side of the fuel cell.

37. The fuel cell system according to claim 35, wherein the water supplied from the independent material supplying portion contains water in exhaust gas emitted from a cathode side of the fuel cell.

38. The fuel cell system according to claim 35, further comprising:
a first combustion portion which burns hydrogen that remains in exhaust gas emitted from an anode of the fuel cell, wherein the water supplied from the independent material supplying portion contains water generated in the first combustion portion.

39. The fuel cell system according to claim 35, further comprising:
a hydrogen separating portion which includes a hydrogen permeable membrane that selectively make hydrogen permeate therethrough, and which separates hydrogen in gas emitted from the fuel reforming apparatus using the hydrogen permeable membrane;
a hydrogen supplying portion which supplies the fuel cell with the hydrogen separated in the hydrogen separating portion; and
a second combustion portion which burns gas that remains after separation of hydrogen in the hydrogen separating portion, wherein the water supplied from the independent material supplying portion contains water generated in the second combustion portion.

40. A fuel cell system, comprising:
the fuel reforming apparatus according to claim 26; and
a fuel cell which generates an electromotive force by an electrochemical reaction, wherein the fuel reforming apparatus includes a hydrogen extracting portion having a hydrogen permeable membrane which selectively makes hydrogen permeate therethrough, and extracts hydrogen from gas containing hydrogen using the hydrogen permeable membrane by being supplied with the gas containing hydrogen generated in the reformer, and operates at a temperature that is higher than that of the fuel cell, and the premixed fuel temperature increasing portion increases a temperature of the premixed fuel using the hydrogen extracted by the hydrogen extracting portion, and supplies the hydrogen used for increasing the premixed fuel for the electrochemical reaction in the fuel cell.

41. A fuel cell system, comprising:
the fuel reforming apparatus according to claim 33; and
a fuel cell which generates an electromotive force by an electrochemical reaction, wherein the fuel reforming apparatus includes a hydrogen extracting portion having a hydrogen permeable membrane which selectively makes hydrogen permeate therethrough, and extracts hydrogen from gas containing hydrogen using the hydrogen permeable membrane by being supplied with the gas containing hydrogen generated in the reformer, and operates at a temperature that is higher than that of the fuel cell, and the premixed fuel temperature increasing portion increases a temperature of the premixed fuel using the hydrogen extracted by the hydrogen extracting portion, and supplies the hydrogen used for increasing the premixed fuel for the electrochemical reaction in the fuel cell.
